(19) United States
(12) Patent Application Publication
(10) Pub. No.: US 2011/0074554 A1
(43) Pub. Date: Mar. 31, 2011

(54) METHOD, DEVICE AND SYSTEM FOR COMMUNICATING IDENTIFICATION INFORMATION

(76) Inventor: Vladimir Sherman, Tel-Aviv (IL)

(21) Appl. No.: 12/993,851

(22) PCT Filed: May 24, 2009
(86) PCT No.: PCT/IL09/00517

§ 371 Date: Nov. 22, 2010

Related U.S. Application Data
(60) Provisional application No. 61/055,147, filed on May 22, 2008.

(51) Int. Cl. H04Q 5/22

(52) U.S. Cl. 340/10.1

(57) ABSTRACT

Disclose is a device method and system for information exchange. According to some embodiments of the present invention, there is provided a user device which includes a directional transmitter, a non-volatile memory adapted to store an identification string and control logic adapted to cause the directional transmitter to intermittently transmit the stored identification string.

### FIELD OF THE INVENTION

The present invention relates generally to the field of electronic identification devices. More specifically, the present invention relates to a method, device and system for communicating identification information between two or more users and between an object and a user.

### BACKGROUND

The business card has been the main medium of contact information exchange for hundreds of years. More recently, the use of person digital assistants (“PDA's”) equipped with Infrared or Radio Frequency transceivers (e.g. Bluetooth, WiFi, etc.) to exchange digital business cards has grown. In many business and social situations, the exchange of a business card or a digital business card is relatively easy and suits the needs of the parties exchanging cards. In other situations, such as at large organized events (e.g. trade events, conferences, seminars, tradeshows, etc.), the manual exchange of contact information with tens or hundreds of people may become cumbersome. Furthermore, for those who intend to generate business or personal “leads” from meetings occurring at an event, which meeting/lead they need to follow-up with after the event, the collection of tens or hundreds or business cards is typically followed by a long and cumbersome period of follow-up calls and/or correspondence.

For tradeshow or trade-event exhibitors interested in gathering sales leads from visitors to their booths, today's lead acquisition systems are cumbersome and require manual scanning of business cards, driver licenses or barcode tags issued to visitors of the event.

For tradeshow or trade-event exhibitors interested in gathering marketing information regarding which exhibitor offerings (i.e. services or products on display at the booth) are of interest to visitors to their booths, real-time visitor interaction and/or visitor observation (manual or recorded video) is required.

There is a need in the field of event based contact information exchange and lead acquisition for improved methods, devices and systems to facilitate the exchange and organization of contact information between people participating in organized events.

There is a need in the field of event based market data gathering for improved methods, devices and systems to facilitate the collection and organization of visitor behavior and/or preference information.

### SUMMARY OF THE INVENTION

According to embodiments of the present invention, there may be provided a wearable user device including a non-volatile memory (“NVM”) adapted to store a device identification string of the user device. The device may also include a directional transmitter adapted to intermittently transmit the identification string through one or more transmission beams pointing substantially in a direction a user of the device would be facing.

According to further embodiments of the present invention, the device may include a directional receiver adapted to device identification strings transmitted by other devices through one or more reception lobes pointing substantially in a direction a user of the device would be facing, and the NVM may be further adapted to store information related to identification strings received from other devices. The related information may include the received identification string itself, time of reception of the received identification string, duration or number of receptions of the identification string.

The transmitter and the receiver may be part of a directional transceiver. The directional transceiver may be an optically based transceiver, for example an Infrared transceiver.

The device may include control logic adapted to regulate data flow between the NVM and the transmitter and receiver. The control logic may also be adapted to cause information related to received identification strings stored in said NVM to be transmitted by said transmitter, for example in the control logic may cause information related to received identification strings to be transmitted in response to a control command from an interface unit of an external data storage system or data processing system.

The device may further include a data acquisition circuit selected such an audio acquisition circuit and/or an image acquisition circuit. The audio acquisition circuit may include a microphone and an analog to digital converter. Data acquired by an acquisition circuit may be stored on the NVM and may be associated with a received identification string. The control logic may associate acquired data with an identification string received in close temporal proximity (e.g. at about the same time) with the time the data was acquired.

According to further embodiments of the present invention, there may be provided a data processing/storage system including one or more data tables adapted to store user information and to store an identification string associated with a user device issued to the user. The system may be integral or otherwise functionally associated an interface unit adapted to communicate with the user device and to retrieve from the user device one or more identification strings received by the device from other devices issued to other users.

The system may further include one or more stationary devices and a stationary device interface adapted to communicate with the one or more stationary devices, wherein the one or more stationary devices may be adapted to communicate with a user device.

The stationary devices may include a directional transceiver adapted to communicate with a user device. The stationary device may also include non-volatile memory adapted to store an identification string associated with the stationary device. The stationary device interface may maintain a communication link with the one or more stationary devices, or the stationary device interface may engage in intermittent communication with the one or more stationary devices.

The system may include comprising an external access control sub-system adapted to provide a user access to information retrieved from the user device. The external access control sub-system may be adapted to correlate and provide user/visitor information associated with identification strings retrieved from the user device. The external access control sub-system may include a web enabled application server adapted to generate browser displayable content.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a functional block diagram of a device according to some embodiments of the present invention;

FIG. 2A shows a symbolic block diagram of two devices interacting with each other and with a data storage/processing system according to some embodiments of the present invention;

FIG. 2B shows a symbolic block diagram of two devices interacting with each other and with a data storage/processing system according to a further embodiment of the present invention;

FIG. 3A shows a symbolic block and signal flow diagram of two user devices interacting with each other and with a data storage/processing system including contact follow-up functionality according to some embodiments of the present invention;

FIG. 3B shows a symbolic block and signal flow diagram of a user device and a stationary device interacting with each other and with a data storage/processing system including contact follow-up functionality according to some embodiments of the present invention;

FIG. 4 is a block diagram of a sub-system of a data storage/processing system according to an embodiment of the present invention including follow-up functionality;

FIG. 5 is flowchart including steps of a method of registering a user/visitor/participant according to some embodiments of the present invention;

FIG. 6 is a flowchart including steps of a method of providing a user with information (contact and other) relating to identification strings (pseudo-id's) collected by the user's device; and

FIG. 7 is a flowchart including steps of a method of facilitating an exchange of contact information between a user requesting another user's contact information and a user who did not authorize other users to see his contact information during a registration process according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Terms in this application relating to distributed data networking, such as send or receive, may be interpreted in reference to Internet protocol suite, which is a set of communications protocols that implement the protocol stack on which the Internet and most commercial networks run. It has also been referred to as the TCP/IP protocol suite, which is named after two of the most important protocols in it: the Transmission Control Protocol (TCP) and the Internet Protocol (IP), which were also the first two networking protocols defined.

According to some embodiments of the present invention, mobile devices may connect with and access data from an enterprise data system over a communication network at some portion of which may be a wireless network. While the term wireless network may technically be used to refer to any type of network that is wireless, the term is most commonly used to refer to a telecommunications network whose interconnections between nodes is implemented without the use of wires, such as a computer network (which is a type of communications network). Wireless telecommunications networks are generally implemented with some type of remote information transmission system that uses electromagnetic waves, such as radio waves, for the carrier and this implementation usually takes place at the physical level or “layer” of the network. (For example, see the Physical Layer of the OSI Model). Various wireless technologies and standards existing, including:

Global System for Mobile Communications (GSM): The GSM network is divided into three major systems which are the switching system, the base station system, and the operation and support system (Global System for Mobile Communication (GSM)). The cell phone connects to the base system station which then connects to the operation and support station; it then connects to the switching station where the call is transferred where it needs to go (Global System for Mobile Communication (GSM)). This is used for cellular phones, is the most common standard and is used for a majority of cellular providers.

Personal Communications Service (PCS): PCS is a radio band that can be used by mobile phones in North America. Sprint happened to be the first service to set up a PCS.

D-AMPS: D-AMPS, which stands for Digital Advanced Mobile Phone Service, is an upgraded version of AMPS but it is being phased out due to advancement in technology. The newer GSM networks are replacing the older system.

Wireless MAN—metropolitan area network.

Wireless LAN—local area networks.

Wireless PAN—personal area networks.

GSM—Global standard for digital mobile communication, common in most countries except South Korea and Japan.

PCS—Personal communication system—not a single standard, this covers both CDMA and GSM networks operating at 1900 MHz in North America.

Mobitex—pager-based network in the USA and Canada, built by Ericsson, now used by PDAs such as the Palm VII and Research in Motion BlackBerry.

GPRS—General Packet Radio Service, upgraded packet-based service within the GSM framework, gives higher data rates and always-on service.

UMTS—Universal Mobile Telephone Service (3rd generation cell phone network), based on the W-CDMA radio access network.

AX.25—amateur packet radio.

NMT—Nordic Mobile Telephony, analog system originally developed by PTTs in the Nordic countries.

AMPS—Advanced Mobile Phone System introduced in the Americas in about 1984.

D-AMPS—Digital AMPS, also known as TDMA.

Wi-Fi—Wireless Fidelity, widely used for Wireless LAN, and based on IEEE 802.11 standards.

Wimax—A solution for BWA (Broadband Wireless Access) and conforms to IEEE 802.16 standard.

Canopy—A wide-area broadband wireless solution from Motorola.

Free Space Optics (FSO) is a telecommunication technology that uses light propagating in free space to transmit data between two points. The technology is useful where the physical connection of the transmit and receive locations is difficult, for example in cities where the laying of fiber optic cables is expensive. Free Space Optics is also used to communicate between space-craft, since outside of the atmosphere there is little to distort the signal. The optical links usually use infrared laser light, although low-data-rate communication over short distances is possible using LEDs. IrDA is a very simple form of free-space optical communications. Distances up to the order of 10 km are possible, but the distance and data rate of connection is highly dependent on atmospheric conditions.

The present invention is a method device and system for exchanging identification information between two or more user devices (e.g. tags), and/or between a user device (e.g. tag) and a stationary device associated with an area (e.g. and interrogator or transmitter located near at an exhibitor booth or conference room) or a stationary device associated with an object (e.g. an interrogator or transmitter located near or connected to an exhibitor offering—next to a new cellphone being offered by Samsung). According to some embodiments of the present invention, a user device may be adapted to transmit an identification string associated with an event visitor. A stationary device may be adapted to transmit an identification string associated with an event related area or object.

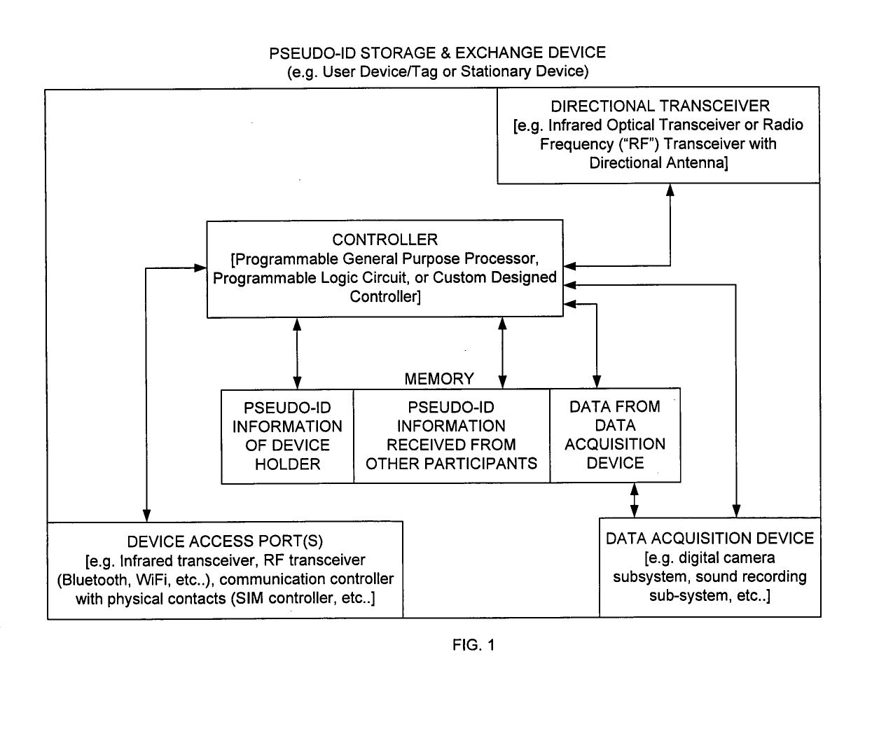

Turning now to FIG. 1, there is shown a functional block diagram of a device according to some embodiments of the present invention.

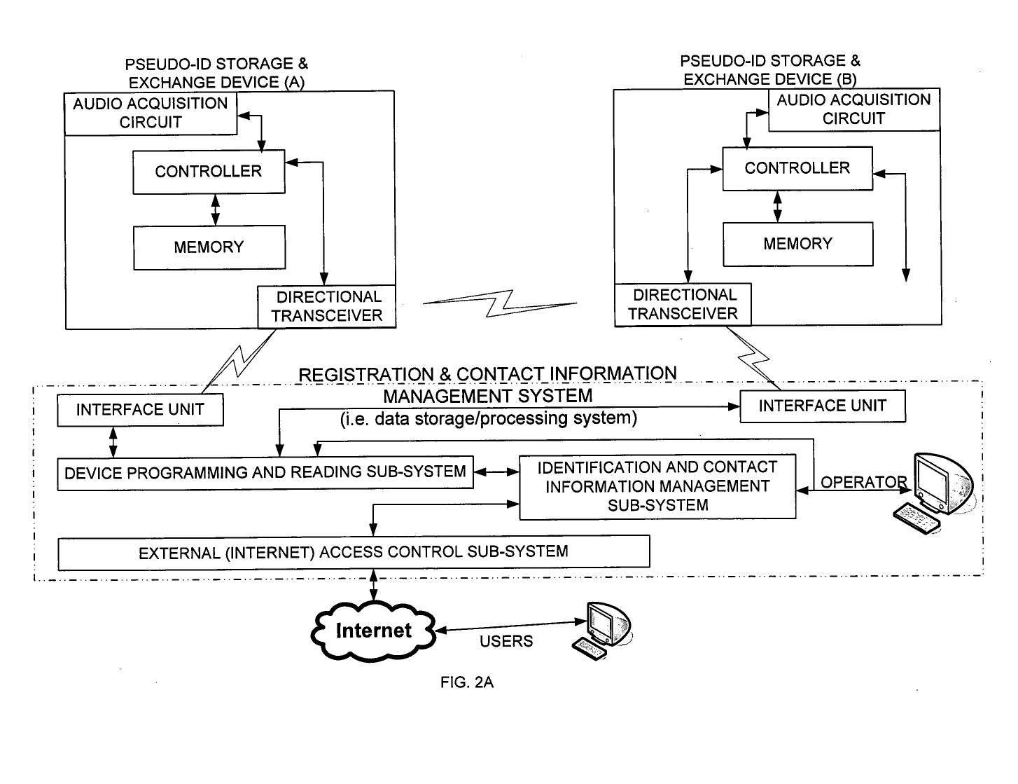

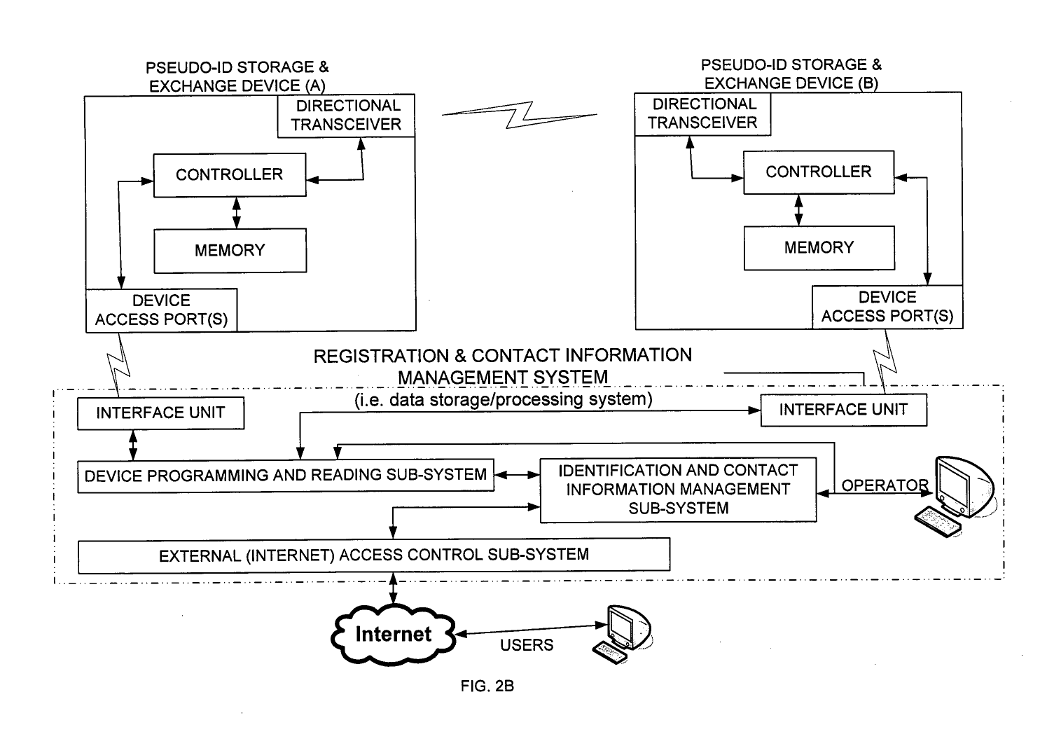

Turning now to FIG. 2A, there is shown a symbolic block diagram of two devices interacting with each other and with a data storage/processing system according to some embodiments of the present invention.

Turning now to FIG. 2B, there is shown a symbolic block diagram of two devices interacting with each other and with a data storage/processing system according to a further embodiment of the present invention.

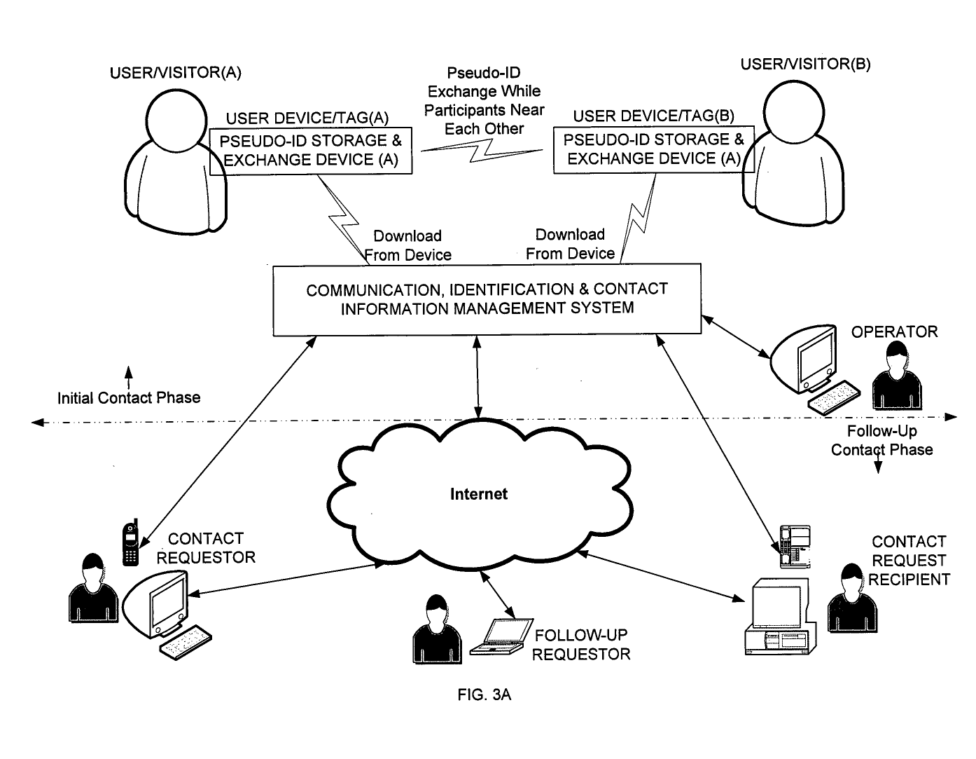

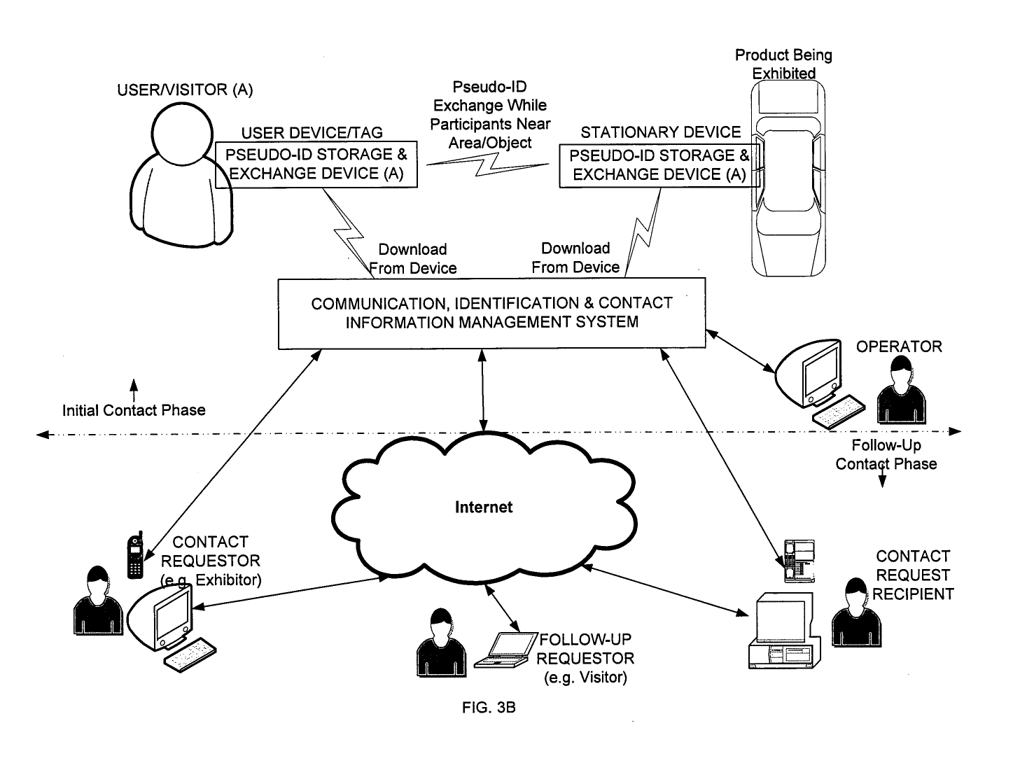

Turning now to FIG. 3A, there is shown a symbolic block and signal flow diagram of two user devices interacting with each other and with a data storage/processing system including contact follow-up functionality according to some embodiments of the present invention.

Turning now to FIG. 3B, there is shown a symbolic block and signal flow diagram of a user device and a stationary device interacting with each other and with a data storage/processing system including contact follow-up functionality according to some embodiments of the present invention.

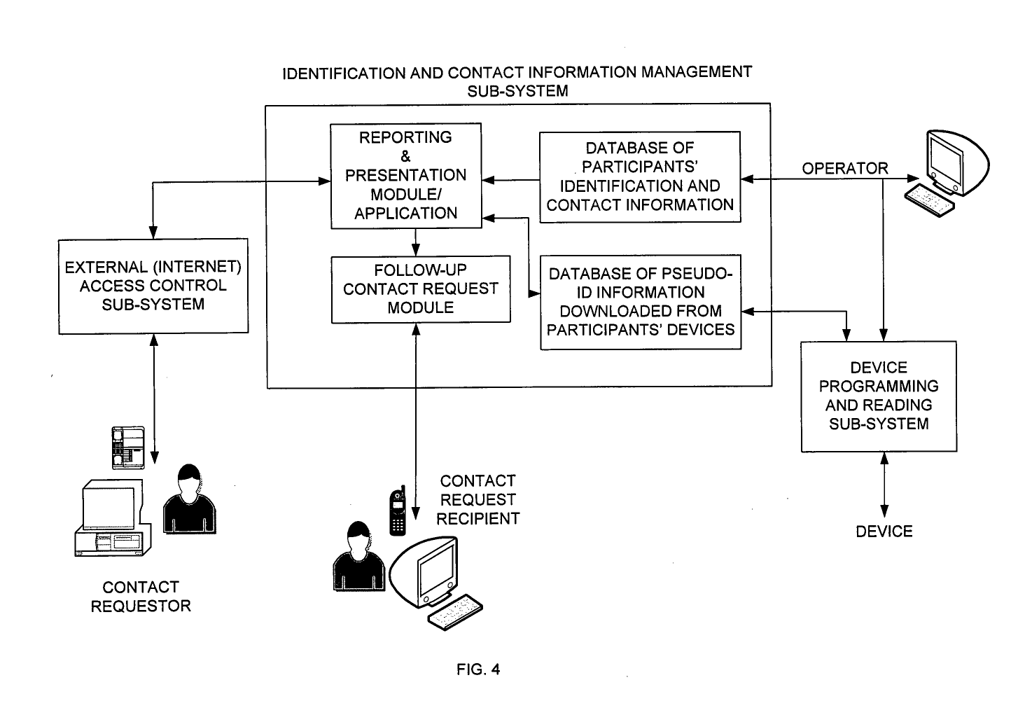

Turning now to FIG. 4, there is shown a block diagram of a sub-system of a data storage/processing system according to an embodiment of the present invention including follow-up functionality.

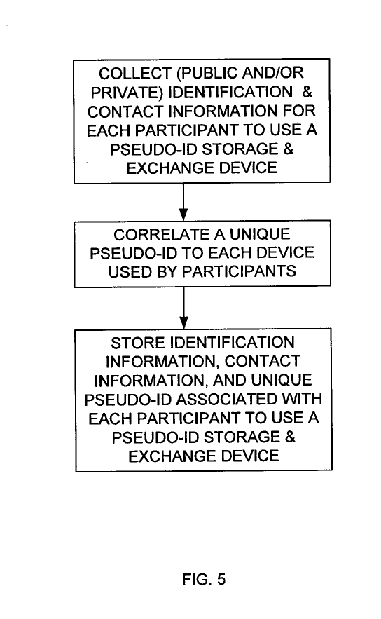

Turning now to FIG. 5, there is shown a flowchart including steps of a method of registering a user/visitor/participant according to some embodiments of the present invention.

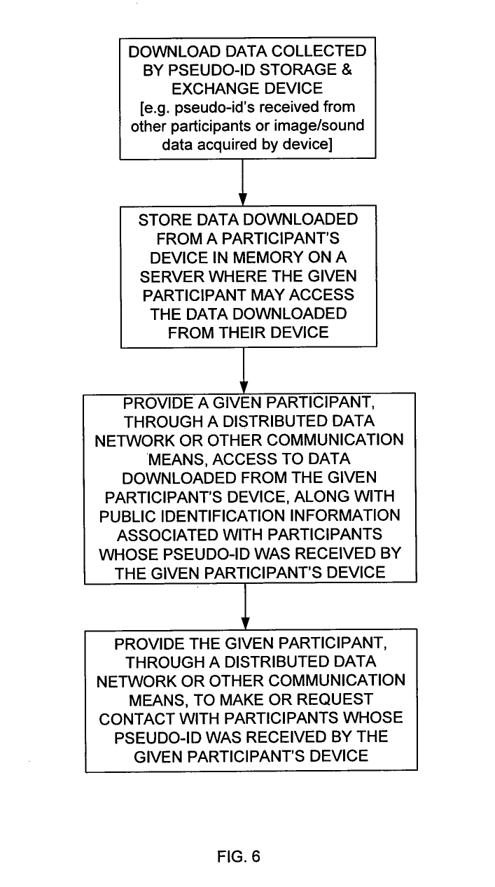

Turning now to FIG. 6, there is shown a flowchart including steps of a method of providing a user with information (contact and other) relating to identification strings (pseudo-id's) collected by the user's device.

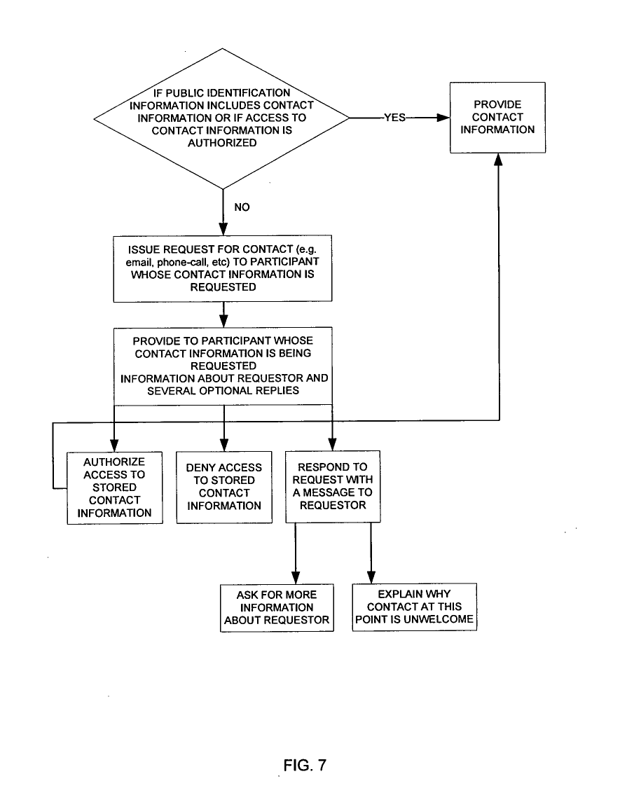

Turning now to FIG. 7, there is shown a flowchart including steps of a method of facilitating an exchange of contact information between a user requesting another user's contact information and a user who did not authorize other users to see his contact information during a registration process according to some embodiments of the present invention.

According to further embodiments of the present invention, a user device may further be adapted to receive and to store identification strings transmitted by either another user device or by a stationary device in proximity (e.g. line of site and/or closer than a predefined distance, for example 2 meters). Both user devices and stationary devices may be adapted to record the time at which another device's identification string was received. According to yet further embodiments of the present invention, when active, both user and stationary devices may be retransmitting their respective identification strings substantially continuously over some interval, and both user and stationary devices receiving a retransmitted identification string may be adapted to estimate and record a duration of time over which each given retransmitted identification sting was being received.

According to some embodiments of the present invention, a user device may be a wearable PSEUDO-ID storage and exchange device or module integral with or otherwise functionally associated with a printed nametag. The user device or module may have a form factor similar to or smaller than that of a name tag or a name tag pouch used to wear and display a nametag. According to some embodiments of the present invention, the user device may be adapted to fit into a nametag pouch or nametag carrier along with a printed nametag. In situations where the user device is placed behind a nametag, it may be adapted to transmit its identification string through the nametag or through openings in the nametag. A user device may also be referred to as a user tag or tag.

According to some embodiments of the present invention, a user device may store in non-volatile memory a PSEUDO-ID string associated or correlated with a given user (e.g. a given event visitor) on a database such as an event registration database. The PSEUDO-ID string may be fixed on the device or may be written to the device when the device is issued to the user, for example during a registration process to the event. During event registration, some of a user's/visitor's information (e.g. first and last name, employer name, position, email, phone number, image, etc.) may be entered into a data storage/processing system functionally associated with the event registration system of the event. The PSEUDO-ID string on a user device/tag issued to the user/visitor may also be stored along with the user's/visitor's other information. According some embodiments of the present invention, a new PSEUDO-ID is generated for each given user/visitor and stored on the given user's/visitor's tag as it is being issued to them. According to further embodiments of the present invention, a tag being issued to a given user/visitor is read/interrogated to determine a PSEUDO-ID already stored on the tag, and the already stored PSEUDO-ID is then stored on the data storage system in a record associated with the visitor.

According to embodiments of the present invention, a user device/tag may include a transmitter, non-volatile memory (“NVM”) and control logic (e.g. controller). The non-volatile memory may be integral with the control logic one a single integrated circuit die or may be part of a separate die electrically in communication with the control logic die. Optionally, the user device/tag may also include a receiver. According to some embodiments of the present invention, the user device/tag may include a transceiver adapted to both transmit and receive data. The transmitter or transceiver may be a directional, and may be adapted to transmit data within a predefined transmission beam. According to further embodiments of the present invention, the receiver or transceiver on the device/tag may be directional, and may be adapted to receive data within a predefined lobe of reception. According to further embodiments of the present invention, the transmitter, the receiver and/or the transceiver may include optical components. According to even further embodiments of the present invention, the transmitter, the receiver and/or the transceiver may include infrared components (e.g. IRDA 2.0 transceiver module).

Data stored on a user device/tag may be accessed and/or modified through the transceiver. According to some embodiments of the present invention, control logic on the user device/tag may be adapted to initiate a configuration mode when a configuration command is received through the receiver/transceiver from an interface unit of a data processing/storage system. During configuration mode, control logic on a given device/tag may provide write, read and/or erase functionality to the NVM of the given device/tag. Thus, during configuration mode: (1) a new identification string (PSEUDO-ID) may be assigned to the given tag, (2) identification strings of other devices/tags received by the given device/tag (along with time and duration information) may be downloaded to an external data storage system, and (3) the device/tag may be initialized, erased and/or reinitialized.

According to further embodiments of the present invention, the user device/tag may include a wired interface circuit such as a USB or RS-232 interface circuit. Wired interface circuits may be used to upload code data to the NVM of the device/tag, to test the device/tag, and/or to perform some or all of the same functions as may be performed through the device/tag transceiver, according to some embodiments of the present invention.

A given user device/tag may include a directional transceiver oriented such that the transceiver's beams of transmission and/or lobes of reception are pointing substantially in a direction a user wearing the tag would be facing. While the given user device/tag is in data exchange mode, the device/tag may continuously or intermittently (over some interval) transmit its identification string. Other devices according to embodiments of the present invention, user device or stationary device, whose lobes of reception overlap the beam of transmission of the given device may receive and/or store the transmitted identification string. If the given device's/tag's lobe of reception overlaps the transmission beam of another device's (user or stationary) transmission, the given device/tag may receive and store an identification string of the other device. According some embodiments of the present invention, the given tag's directional transceiver (e.g. IRDA optics) may be oriented such that: (1) it will transmit substantially in the direction a user of the device/tag is facing, and (2) receive identification strings from devices (user and stationary) substantially in-front of and transmitting towards the user. According to some embodiments of the present invention, a first user device/tag of a first user may receive a second identification string from a second user device/tag of a second user when the first and second users are in proximity (e.g. within 2 meters) of one another and generally facing each other's direction (e.g. +−80 deg). The second user device/tag may likewise receive a first identification string transmitted by the first user device/tag when the first and second users are proximity and generally facing each other's direction. Accordingly, either or both of the user devices/tags may receive and store the identification strings of the other. Optionally, either or both devices may record the time and duration of identification string reception. The same interaction features and constraints (i.e. exchange of identification strings, time, duration, etc.) as described for two user devices/tags may apply to interaction between a user device/tag and a stationary device.

According to embodiments of the present invention, a stationary device may include its own identification string and a user device/tag may receive and record the identification string of the stationary device. A data storage/processing system may associate the stationary device's identification string with an area or object to which the stationary device was assigned. According to some embodiments of the present invention, a stationary device may include some or all of the same components and functionality as a user device/tag. The stationary device may receive and record identification strings of user devices/tags, and the received identification strings may be downloaded to the data storage/processing system intermittently, either through a transceiver of the stationary device or through other interface circuits/units associated with the stationary device and the data storage/processing system. According to further embodiments of the present invention, the stationary device may be substantially continuously connected to a node of the data processing/storage system and may send the node information about received identification strings continuously.

According to some embodiments of the present invention, a stationary device may act as interrogation point or interrogator of user devices/tags passing by, updating a data storage/processing system in real-time as user devices/tags pass by. According to further embodiments of the present invention, the data storage/processing system may check received identification strings for area access permission and may provide real-time feedback regarding area access permission through an access control station—thereby providing access control functionality.

According to some embodiments of the present invention, the data processing/storage system may include one or more data tables adapted to store user information and to store an identification string associated with a user device issued to the user. The data storage/processing system may be integral with or otherwise functionally associated with one or more interface units adapted to communicate with a user device/tag and to retrieve from the user device/tag one or more identification strings received by the device/tag from stationary devices or from other devices/tags issued to other users. The interface unit may also be adapted to download from a user device/tag other data associated with a received identification string. According to further embodiments, along with downloading a given received identification string, the interface unit may also download other information associated with the given string, including time of receipt of string (i.e. time of meeting), duration of receipt of identification string (i.e. duration of meeting), and/or data acquired by a device's/tag's acquisition circuit (e.g. image or audio data/message recorded concurrent or shortly after receiving the given identification string). The data storage/processing system may correlate in its data tables a given received/downloaded identification string with: (1) other downloaded data/information associated with the received/downloaded identification string, (2) the identification string of the device/tag from which the identification string and data were downloaded, and/or (3) available contact information relating to respective users/visitors/areas/objects with which the received/downloaded identification strings were associated.

According to embodiments of the present invention, interface unit(s) may be adapted to retrieve from a stationary device identification strings received by the stationary device from user devices/tags. According to further embodiments of the present invention, the data storage/processing system may be integral with or otherwise functionally associated one or more stationary devices and may be adapted to communicate with the one or more stationary devices intermittently or substantially continuously through an interface unit.

According to some embodiments of the present invention, the data storage/processing system may include or be functionally associated with an external access control sub-system adapted to provide a user access to information retrieved from the user device. The external access control sub-system, or another functionally associated sub-system, may correlate and provide user/visitor information associated with identification strings (e.g. time of meeting, duration of meeting, any data acquired during meeting—for example audio recording) retrieved from the user device. The external access control sub-system may includes or be functionally associated with a web enabled application server adapted generate browser displayable content based on identification strings retrieved from a user or a stationary device.

During or after an event, a user may have the identification strings (PSEUDO-ID's) received by and collected from his/her respective user device downloaded to a computer system such as a web enable data storage/processing system associated with the event. The computer system may correlate a downloaded PSEUDO-ID with its respective visitor's/user's available contact information. The contact information, and/or any other associated information (e.g. time of meeting, duration of meeting, audio data acquired during or after the meeting), may be provided to a user via a web interface or via any other communication means known today or to be devised in the future.

In situations where a received/downloaded identification string is associated with an area (e.g. booth of an exhibitor) or an object (e.g. exhibited product), information about the area (i.e. the exhibitor) or product may be provided by the data storage/processing system. Area or product related information may be provided in the form of Universal Retrieval Language (“URL”) links.

According to further embodiments of the present invention, based on data retrieved from stationary devices, the data storage/processing system may provide an exhibitor with information relating to users/visitors who entered their booth and/or looked at one of their products.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A user device wearable by a user, said device comprising:
non-volatile memory (“NVM”) adapted to store a device identification string of the user device;
a directional transmitter adapted to intermittently transmit the identification string through one or more transmission beams pointing substantially in a direction a user of the device would be facing.

2. The user device according to claim 1, further comprising a directional receiver adapted to device identification strings transmitted by other devices through one or more reception lobes pointing substantially in a direction a user of the device would be facing.

3. The user device according to claim 2, wherein said NVM is further adapted to store information related to identification strings received from other devices.

4. The user device according to claim 3, wherein related information is information selected from the group consisting of the received identification string itself, time of reception of the received identification string, duration or number of receptions of the identification string.

5. The device according to claim 3, wherein said directional transmitter and directional receiver are part of a directional transceiver.

6. The device according to claim 5, wherein said directional transceiver is an infrared transceiver.

7. The device according to claim 3, further comprising control logic adapted to regulate data flow between said NVM and said transmitter and receiver.

8. The device according to claim 7, wherein said control logic is adapted to cause information related to received identification strings stored in said NVM to be transmitted by said transmitter.

9. The device according to claim 8, wherein said control logic causes information related to received identification strings to be transmitter in response to a control command from an interface unit of an external data storage or data processing system.

10. The device according to claim 3, further comprising a data acquisition circuit selected from a group of circuits consisting of audio acquisition circuits and image acquisition circuits.

11. The device according to claim 10, wherein said control logic is adapted to associate data acquired through the acquisition circuit with a received identification string.

12. A user data processing/storage system comprising:
one or more data tables adapted to store user information and to store an identification string associated with a user device issued to the user;
an interface unit adapted to communicate with the user device and to retrieve from the user device one or more identification strings received by the device from other devices issued to other users.

13. The system according to claim 11, further comprising one or more stationary devices and a stationary device interface adapted to communicate with the one or more stationary devices, wherein the one or more stationary devices are adapted to communicate with a user device.

14. The system according to claim 12, wherein a stationary device includes a directional transceiver adapted to communicate with a user device.

15. The system according to claim 13, wherein a stationary device includes non-volatile memory adapted to store an identification string associated with the stationary device.

16. The system according to claim 13, wherein said stationary device interface maintains a communication link with the one or more stationary devices.

17. The system according to claim 13, wherein said stationary device interface engages in intermittent communication with the one or more stationary device.

18. The system according to claim 11, further comprising an external access control sub-system adapted to provide a user access to information retrieved from the user device.

19. The system according to claim 17, wherein the external access control sub-system is adapted to correlate and provide user/visitor information associated with identification strings retrieved from the user device.

20. The system according to claim 18, wherein said external access control sub-system includes a web enabled application server adapted generate browser displayable content.
